(19) United States
(12) Patent Application Publication
(10) Pub. No.: US 2025/0208807 A1
(43) Pub. Date: Jun. 26, 2025

(54) IMAGE FORMING APPARATUS, PRINT CONTROL METHOD, AND COMPUTER READABLE MEDIUM

(71) Applicant: CANON KABUSHIKI KAISHA, Tokyo (JP)

(72) Inventor: Kazuya Sato, Kanagawa (JP)

(21) Appl. No.: 18/983,770

(22) Filed: Dec. 17, 2024

(30) Foreign Application Priority Data
Dec. 25, 2023 (JP) 2023-217860

(51) Int. Cl. G06F 3/12

(52) U.S. Cl. CPC G06F 3/1261; G06F 3/1208; G06F 3/1238; G06F 3/1274

(57) ABSTRACT

In a case where a specific type of sheet associated with print data is not loaded in an image forming apparatus and an alternative type of sheet is loaded in the image forming apparatus, a print engine unit is caused to execute printing based on the print data on the alternative type of sheet.

### BACKGROUND OF THE DISCLOSURE

### Field of the Disclosure

The present invention relates to an image forming apparatus, a print control method, and a computer readable medium.

### Description of the Related Art

Printing apparatuses equipped with image forming apparatuses conventionally use recording media such as sheets of various types and sizes. Usually, the type and size of such a recording medium are designated in accordance with the user's operations on a host apparatus that transmits a print job to the printing apparatus. Thus, a print job contains information designating the type and size of a recording medium. In a printing apparatus disclosed in Japanese Patent Laid-Open No. 2001-18494 (hereinafter referred to as the document), in a case where a recording medium of the same size and type as those of a recording medium designated in a print job is not loaded, a recording medium of either the same size or the same type is selected as a printing target.

Here, the printing apparatus of the document may execute alternative printing on, for example, a recording medium that has the same size as the sheet designated in a print job but is of a different type from the sheet. That is, the printing apparatus may execute alternative printing on a type of sheet different from the type of sheet designated in a print job. Such a case may lead to a failure to perform printing with the print quality desired by the user.

### SUMMARY OF THE DISCLOSURE

An embodiment of the present disclosure provides an image forming apparatus including an execution control unit that, in a case where a specific type of sheet associated with print data is not loaded in the image forming apparatus and an alternative type of sheet is loaded in the image forming apparatus, causes a print engine unit to execute printing based on the print data on the alternative type of sheet.

Further features of the present disclosure will become apparent from the following description of exemplary embodiments with reference to the attached drawings.

### BRIEF DESCRIPTION OF THE DRAWINGS

FIG. 1 is a diagram illustrating a schematic internal configuration of an image forming apparatus according to an embodiment of the present disclosure;

FIG. 2 is a flowchart for describing a print control method according to a first embodiment of the present disclosure;

FIG. 3 is an example of a screen for selecting a sheet type and a print quality on a host apparatus;

FIG. 4 is an example of a table indicating groups of alternative types of sheets in the first embodiment of the present disclosure;

FIGS. 5A and 5B are screens to be displayed in the print control method according to the first embodiment of the present disclosure;

FIG. 6 is a flowchart for describing a print control method according to a second embodiment of the present disclosure;

FIGS. 7A and 7B are screens to be displayed in the print control method according to the second embodiment of the present disclosure;

FIG. 8 is a flowchart for describing a print control method according to a third embodiment of the present disclosure;

FIG. 9 is a screen to be displayed in the print control method according to the third embodiment of the present disclosure;

FIG. 10 is a flowchart for describing a print control method according to a fourth embodiment of the present disclosure;

FIGS. 11A and 11B are screens to be displayed in the print control method according to the fourth embodiment of the present disclosure;

FIG. 12 is an example of a table indicating groups of alternative types of sheets in a fifth embodiment of the present disclosure;

FIG. 13 is another example of a screen for selecting a sheet type and a print quality on a host apparatus;

FIG. 14 is still another example of a screen for selecting a sheet type and a print quality on a host apparatus; and

FIG. 15 is yet another example of a screen for selecting a sheet type and a print quality on a host apparatus.

### DESCRIPTION OF THE EMBODIMENTS

Embodiments will be described in detail below with reference to the accompanying drawings. It is to be noted that the following embodiments do not limit the disclosure set forth in the claims. Moreover, although multiple features are described in the embodiments, not all of these features are necessarily essential for the disclosure, and the multiple features may be combined in any ways. Furthermore, in the accompanying drawings, identical or similar components are denoted by the same reference numeral, and overlapping description may be omitted.

### First Embodiment

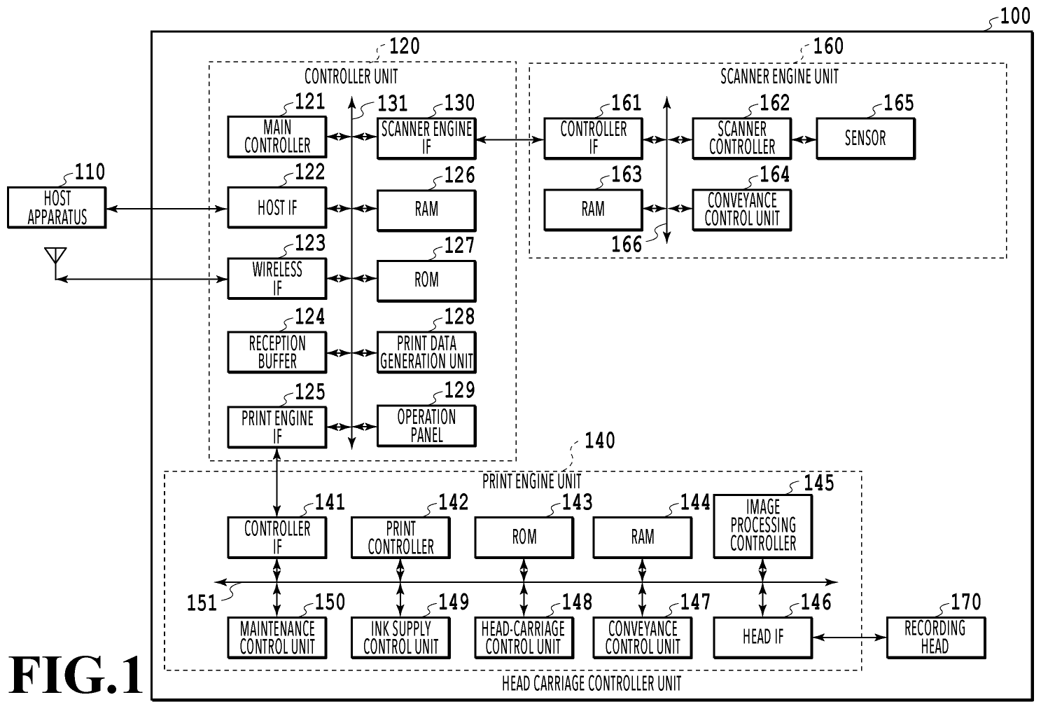

FIG. 1 is a diagram illustrating a schematic configuration of an image forming apparatus 100 according to a first embodiment.

In FIG. 1, the image forming apparatus 100 includes a controller unit 120, a print engine unit 140, a scanner engine unit 160, and a recording head 170.

Also, the image forming apparatus 100 is connectable to a host apparatus 110 through a host IF 122 or a wireless IF 123. Note that “IF” stands for an interface.

The controller unit 120 has a main controller 121, a reception buffer 124, a print engine IF 125, a scanner engine IF 130, a random-access memory (RAM) 126, a read-only memory (ROM) 127, a print data generation unit 128, and an operation panel 129. The controller unit 120 also has the host IF 122 and the wireless IF 123 for external connection. The components in the controller unit 120 are connected to one another through a system bus 131.

The main controller 121, which includes a central processing unit (CPU), for example, controls the operation of the entire image forming apparatus 100 by performing printing and maintenance operations in accordance with programs and various parameters stored in the ROM 127 with the RAM 126 as a work area.

For example, in a case where data is input as a print job into the image forming apparatus 100 from the host apparatus 110 through the host IF 122, that data is saved to the reception buffer 124. The print data generation unit 128 performs predetermined image processing on the data stored in the reception buffer 124 in accordance with an instruction from the main controller 121 to render the data into print data. The print data may be transferred to a non-volatile device, such as a hard disk drive (HDD), or to a volatile device, such as a RAM.

The main controller 121 then transmits the print data subjected to the image processing to the print engine unit 140 through the print engine IF 125.

Also, in a case where, for example, a read command is input as a read job from the host apparatus 110, the main controller 121 transmits that read command to the scanner engine unit 160 through the scanner engine IF 130.

The RAM 126 is, for example, used as a work area for the main controller 121 and an area to temporarily store various data, and to store various setting data.

The ROM 127 stores programs to be run by the main controller 121 and various data necessary for various operations of the image forming apparatus 100.

The print data generation unit 128 includes various image processing means. The print data generation unit 128 performs, for example, a process of translating (converting) received data to be handled in the image forming apparatus 100 (e.g., data represented in a page description language) into print data (bitmap image data) and other image processing. Moreover, the print data generation unit 128 converts the color space of image data contained in the input received data (e.g., YCbCr) into a standard RGB color space (e.g., sRGB). Furthermore, the print data generation unit 128 performs various kinds of image processing on the receive data such as resolution conversion into an effective pixel count (a number with which the image forming apparatus 100 can perform print processing), image analysis, image correction, and data compression and decompression as necessary.

The print data obtained by these kinds of image processing is then stored in the RAM 126.

The operation panel 129 includes hardware keys and a panel for the user to perform various operations, and a display unit which displays various information to the user (notifies the user of the various information). The operation panel 129 may also notify the user of information by outputting a sound (such as a buzzer sound or speech) based on sound information from an audio generator (not illustrated).

The print engine unit 140 is a printing unit that forms images. The print engine unit 140 includes a controller IF 141, a print controller 142, a ROM 143, a RAM 144, and an image processing controller 145. The print engine unit 140 also includes a maintenance control unit 150, an ink supply control unit 149, a head-carriage control unit 148, a conveyance control unit 147, and a head IF 146 for performing various types of control. These components are connected to one another through a system bus 151. The print engine unit 140 is connected to the recording head 170 through the head IF 146.

The print controller 142, which includes a CPU, for example, controls various mechanisms included in the print engine unit 140 in accordance programs and various parameters stored in the ROM 143 with the RAM 144 as a work area.

In a case where the print engine unit 140 receives any of various commands or print data through the controller IF 141, the print controller 142 temporarily saves this to the RAM 144.

The print controller 142 causes the image processing controller 145 to convert the print data saved in the RAM 144 into recording data. The recording head 170 can be utilized to perform a recording operation with the converted recording data.

After the recording data is generated as a result of the conversion, the print controller 142 causes the recording head 170 to execute a recording operation based on the recording data. In doing so, the print controller 142 requests the conveyance control unit 147 to convey a recording medium with a conveyance roller. Following an instruction from the print controller 142, the recording head 170 executes a recording operation in conjunction with the operation of conveying the recording medium to perform print processing.

The head carriage control unit 148 changes the direction and position of the recording head 170 according to the operating status of the image forming apparatus 100 such as whether the image forming apparatus 100 is in a maintenance state or in a recording state.

The ink supply control unit 149 performs control such that the pressures of inks to be supplied to the recording head 170 stay within appropriate ranges.

The maintenance control unit 150 controls cleaning of the conveyance roller controlled by the conveyance control unit 147 and the recording head 170.

The recording head 170 is a printing unit that performs image printing, and prints an image on a recording medium based on recording data.

The recording head 170 holds multiple print heads for respective colors, for example, and forms an image on a recording medium, such as paper, by causing the print heads to discharge inks in synchronization with conveyance of the recording medium.

Note that the image forming apparatus 100 according to the present embodiment will be described by taking an inkjet printer that uses inks as recording materials as an example, but is not limited to this type.

The present disclosure is applicable to printing apparatuses of various printing methods such as thermal printers (sublimation type, heat transfer type, etc.), dot impact printers, and electrophotographic printers such as light emitting diode (LED) printers and laser printers.

The scanner engine unit 160 includes a controller IF 161, a RAM 163, a scanner controller 162, a conveyance control unit 164, and a sensor 165. These components are connected to one another through a system bus 166.

The main controller 121 controls hardware resources of the scanner controller 162 according to programs and various parameters stored in the ROM 127 with the RAM 126 as a work area. As a result, various mechanisms included in the scanner engine unit 160 are controlled.

For example, the main controller 121 controls hardware resources in the scanner controller 162 via the controller IF 161. As a result, the scanner engine unit 160 conveys a document set by the user with the conveyance control unit 164 and reads it with the sensor 165. The scanner controller 162 then saves the read data to the RAM 163.

Note that, in the present embodiment, the operation panel 129 is present in the image forming apparatus 100 but is not limited to this configuration, and may be connected to the image forming apparatus 100 as an external component through the host IF 122, for example. Also, the host apparatus 110 may also serve as the operation panel 129. Furthermore, the image forming apparatus 100 may be configured such that other input-output apparatuses can be connected thereto through the host IF 122 or the like in addition to the operation panel 129.

Also, in the present embodiment, print data and read data are saved in the RAMs 126, 163, and 144, which are volatile memories, but may be saved in non-volatile memories, such as HDDs.

The host apparatus 110 is an external apparatus that serves as a supply source of print data and, for example, is a personal computer (PC) or a server apparatus in which a printer driver has been installed. A data providing apparatus that serves as a supply source of print data such as a digital camera or a smartphone, for example, may be provided instead of the host apparatus 110.

The form of connection between the image forming apparatus 100 and each apparatus is not limited to one through the host IF 122, and they may be connected via wireless communication through the wireless IF 123, for example.

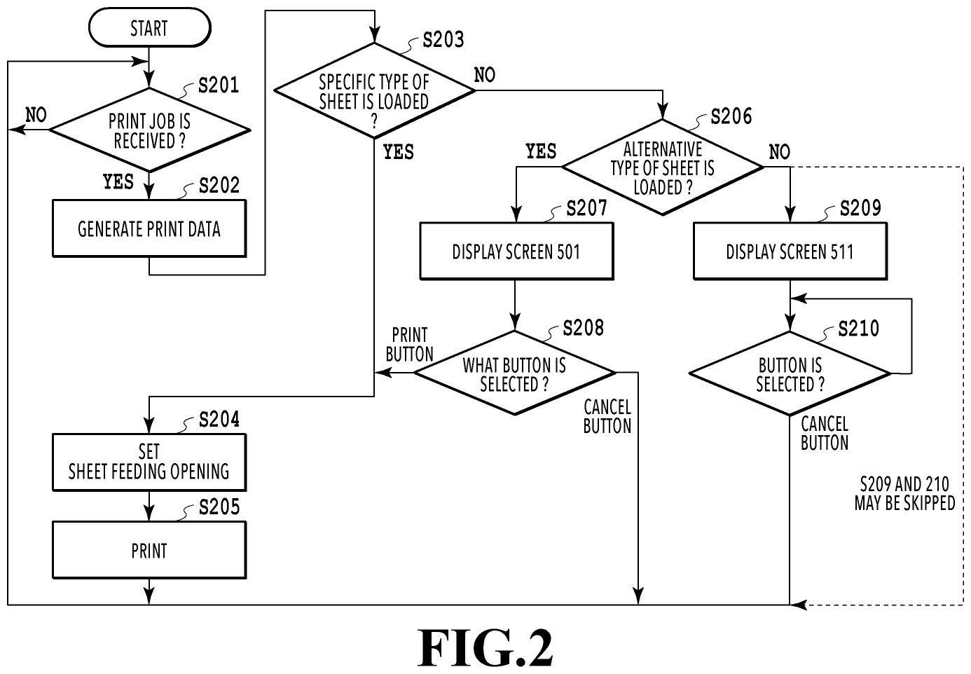

FIG. 2 is a flowchart for describing a print control method according to the first embodiment. Referring to FIG. 2, first, in a wait loop in step S201, the main controller 121 waits for a print job to be transmitted from the host apparatus 110 through the host IF 122 or the wireless IF 123. In the following description, “step S_” will be abbreviated as “S_.”

In a case where a print job is transmitted from the host apparatus 110, the main controller 121 determines YES in S201 and advances the process to S202. At this time, the main controller 121 stores the received print job in the reception buffer 124.

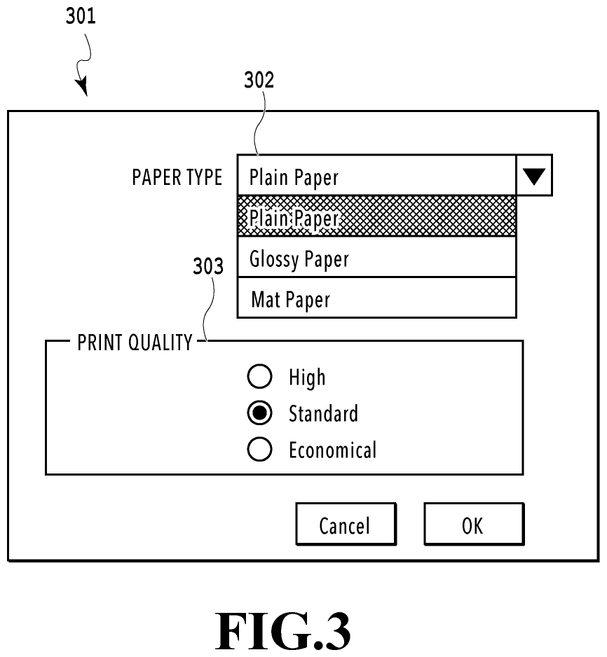

In S202, the print data generation unit 128 generates print data based on the print job stored in the reception buffer 124 in response to an instruction from the main controller 121. Note that the print data is adjusted such that printing will be performed on a specific type of sheet designated in the print job with a print quality designated in the print job. Thus, in a case of performing printing based on this print data on the specific type of sheet designated in the print job, it is possible to perform the printing with the print quality designated in the print job. This means that the print data generated in S202 and the specific type of sheet designated in the print job are associated with each other. Incidentally, a screen 301 as illustrated in FIG. 3 is displayed on the host apparatus 110 by the printer driver. The screen 301 includes a menu 302 for the user to select a sheet type and a menu 303 for the user to select a print quality as display objects. The user utilizes this screen 301 to designate a sheet type and a print quality. The print job contains data on a sheet type designated by the user from the menu 302 included in this screen 301 and a print quality designated by the user from the menu 303 included in the screen 301.

Next, in S203, the main controller 121 determines whether the specific type of sheet is loaded in any of sheet feed trays. Note that the type and size of the sheets loaded in each sheet feed tray is stored in a predetermined storage area (e.g., the RAM 144 with a backup power supply) as sheet feed tray-sheet information. Incidentally, in a case where the user changes sheets, they can operate the operation panel 129 to rewrite the sheet feed tray-sheet information to the sheet type and size to the changed sheets.

If the specific type of sheet is loaded in any of the sheet feed trays, the main controller 121 determines YES in S203, and advances the process to S204.

In S204, the conveyance control unit 147 sets a sheet feeding opening to the sheet feed tray in which the specific type of sheet is loaded in response to an instruction from the main controller 121.

Next, in S205, the print engine unit 140 executes printing on the specific type of sheet in response to an instruction from the main controller 121.

If the specific type of sheet is not loaded in any of the sheet feed trays, the main controller 121 determines NO in S203, and advances the process to S206.

Next, in S206, the main controller 121 determines whether an alternative type of sheet is loaded in any of sheet feed trays. Here, an alternative type of sheet means a type of sheet that can be an alternative to the specific type of sheet in terms of print quality in a case of printing the print data generated in S202.

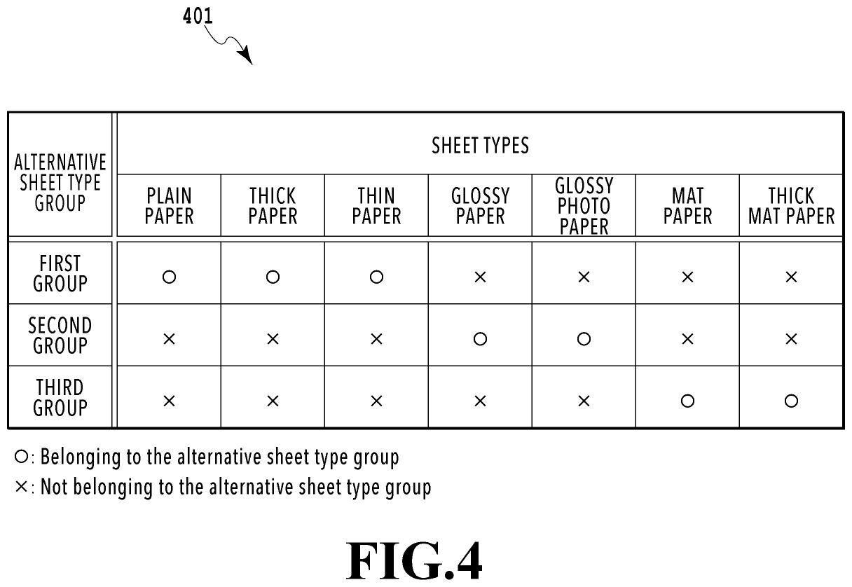

FIG. 4 illustrates a table 401 indicating groups of sheet types each of which can be an alternative to the other or the others. The table 401 is stored in the ROM 127, which is accessible to the main controller 121, for example. The main controller 121 refers to the table 401 to find an alternative type of sheet to the specific type of sheet. In the table 401, plain paper, thick paper, and thin paper belong to a first group, glossy paper and glossy photo paper belong to a second group, and mat paper and thick mat paper belong to a third group as an example. In a case where the specific type of sheet belongs to any of the groups, another type of sheet belonging to that group is an alternative type of sheet. In one example, in a case where the specific type of sheet is plain paper, its alternative types of sheets are thick paper and thin paper. In another example, in a case where the specific type of sheet is thick paper, its alternative types of sheets are plain paper and thin paper.

If an alternative type of sheet is loaded in any of the sheet feed trays, the main controller 121 determines YES in S206, and advances the process to S207.

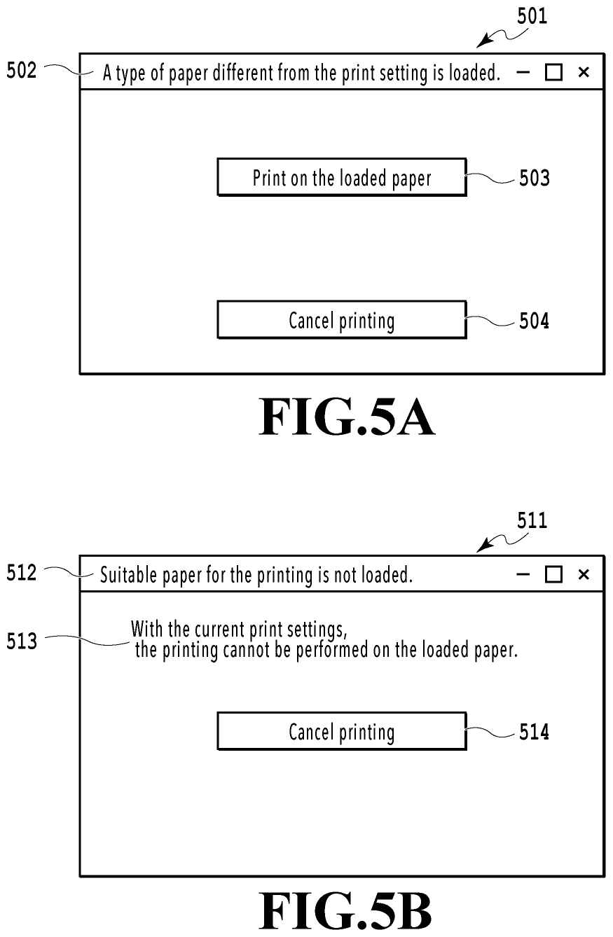

In S207, the main controller 121 displays a screen 501 illustrated in FIG. 5A on the display unit (not illustrated) included in the operation panel 129. The screen 501 includes, as display objects, a title 502 “A type of paper different from the print setting is loaded,” a print button 503 with a caption “Print on the loaded paper,” and a print cancel button 504 with a caption “Cancel printing.”

If the user presses the print button 503 in the screen 501, the main controller 121 advances the process from S207 to S204 through S208.

In this case, in S204, the conveyance control unit 147 sets the sheet feeding opening to the sheet feed tray in which the alternative type of sheet is loaded in response to an instruction from the main controller 121. In a case where there are multiple alternative types of sheets, the type of sheet with a higher priority or the highest priority is selected. The priority may be added to the table 401, or the sheet types in each row of the table 401 may be in order of priority, for example.

Next, in S205, the print engine unit 140 executes printing on the alternative type of sheet in response to an instruction from the main controller 121.

If the user presses the print cancel button 504 in the screen 501, the main controller 121 returns the process from S207 to S201 through S208.

If no alternative type of sheet is loaded in any of the sheet feed trays, the main controller 121 determines NO in S206, and advances the process to S209.

In S209, the main controller 121 displays a screen 511 illustrated in FIG. 5B on the display unit (not illustrated) included in the operation panel 129. The screen 511 includes, as display objects, a title 512 “Suitable paper for the printing is not loaded,” a message 513 “With the current print settings, the printing cannot be performed on the loaded paper,” and a print cancel button 514 with a caption “Cancel printing.”

If the user presses the print cancel button 514 in the screen 511, the main controller 121 returns the process from S209 to S201 through S210.

Note that the main controller 121 may return the process to S201 without going through S209 and S210 if NO in S206. In this case, neither the screen 501 nor 511 is displayed.

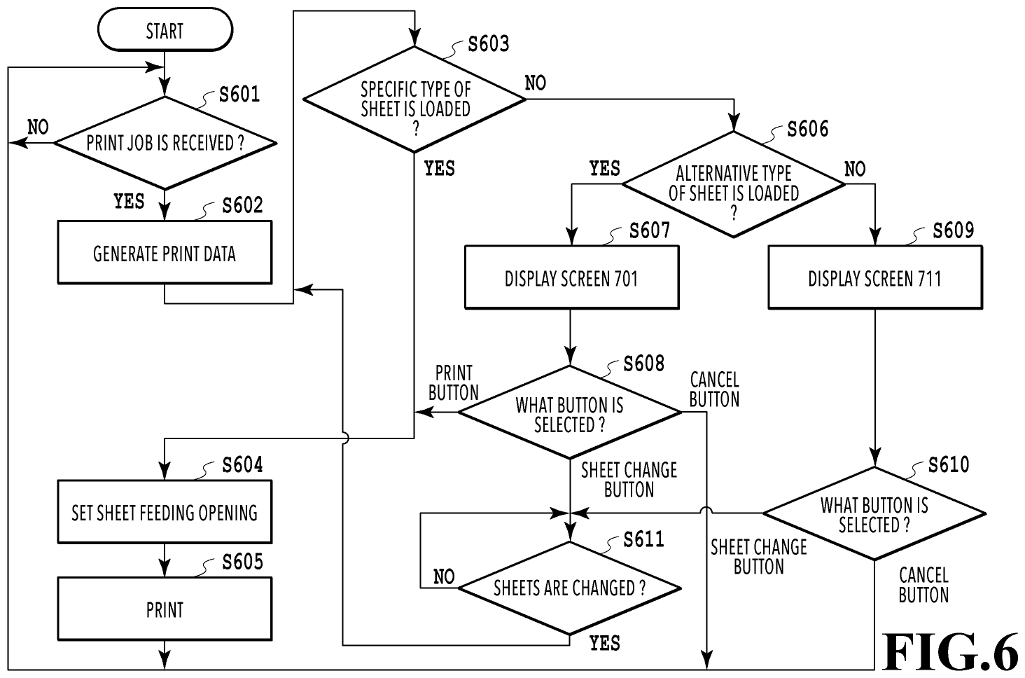

In the method illustrated in FIG. 2, the main controller 121 functions as a display control unit in the steps related to displaying screens, and functions as an execution control unit in at least some of the other steps. This applies to the later-described methods illustrated in FIGS. 6, 8, and 10 as well.

According to the first embodiment, in a case where the specific type of sheet is not loaded in any of the sheet feed trays, an alternative type of sheet is loaded in any of the sheet feed trays, and the user has granted permission, alternative printing can be performed on the alternative type of sheet. On the other hand, in a case where the specific type of sheet is not loaded in any of the sheet feed trays and no alternative type of sheet is loaded in any of the sheet feed trays, no alternative printing will be performed. This avoids execution of printing with a print quality which the user did not intend to use.

Also, according to the first embodiment, in a case where the specific type of sheet is not loaded in any of the sheet feed trays and an alternative type of sheet is loaded in any of the sheet feed trays but the user has not granted permission, alternative printing will not be performed on the alternative type of sheet. In this way, if the user does not wish to execute alternative printing, it possible to avoid the alternative printing based on the user's decision even in a situation where the alternative printing can be performed. Note that the user may enable such a setting in advance as to advance the process directly to S204 and S205 without going through S207 and S208 in the case of YES in S206. Specifically, as long as the user has enabled such a setting as to always permit alternative printing, alternative printing may always be executed in a case where the specific type of sheet is not loaded in any of the sheet feed trays and an alternative type of sheet is loaded in any of the sheet feed trays.

In a case where an alternative type of sheet is loaded in the image forming apparatus 100 but the size of the specific type of sheet differs from the size of the loaded alternative type of sheet, no alternative type of sheet may be considered to be loaded in the image forming apparatus 100. Alternatively, in such a case, an alternative type of sheet may be determined to be loaded in the image forming apparatus 100, and enlarged or reduced printing may be performed. A display object for displaying whether the sheet sizes match or not and a display object for performing enlarged or reduced printing may be added to the screen 501. These apply to the other embodiments as well.

A specific example will now be described with reference to the table illustrated in FIG. 4. For example, in a case where “PLAIN PAPER” is set as the sheet type in a print job, the specific type of sheet is “PLAIN PAPER” and its alternative types of sheets are “THICK PAPER” or “THIN PAPER.” Thus, in a case where “PLAIN PAPER” is set as the sheet type in a print job and “PLAIN PAPER” is loaded in the image forming apparatus 100, printing will be executed on the “PLAIN PAPER,” which is the specific type of sheet. Also, in a case where a similar print job is given but “PLAIN PAPER” is not loaded in the image forming apparatus 100 and “THICK PAPER” or “THIN PAPER” is loaded instead, printing will be executed on “THICK PAPER” or “THIN PAPER,” which is an alternative type of sheet, on condition that the user grants permission. On the other hand, in a case where a similar print job is given but none of “PLAIN PAPER,” “THICK PAPER,” or “THIN PAPER” is loaded in the image forming apparatus 100, printing will not be executed even if another type of sheet is loaded.

Also, in a case where “THICK PAPER” is set as the sheet type in a print job, the specific type of sheet is “THICK PAPER” and its alternative types of sheets are “PLAIN PAPER” or “THIN PAPER.” Thus, in a case where “THICK PAPER” is set as the sheet type in a print job and “THICK PAPER” is loaded in the image forming apparatus 100, printing will be executed on the “THICK PAPER,” which is the specific type of sheet. Also, in a case where a similar print job is given but “THICK PAPER” is not loaded in the image forming apparatus 100 and “PLAIN PAPER” or “THIN PAPER” is loaded instead, printing will be executed on “PLAIN PAPER” or “THIN PAPER,” which is an alternative type of sheet, on condition that the user grants permission. On the other hand, in a case where a similar print job is given but none of “PLAIN PAPER,” “THICK PAPER,” or “THIN PAPER” is loaded in the image forming apparatus 100, printing will not be executed even if another type of sheet is loaded.

Further, in a case where “GLOSSY PAPER” is set as the sheet type in a print job, the specific type of sheet is “GLOSSY PAPER” and its alternative type of sheet is “GLOSSY PHOTO PAPER.” Thus, in a case where “GLOSSY PAPER” is set as the sheet type in a print job and “GLOSSY PAPER” is loaded in the image forming apparatus 100, printing will be executed on the “GLOSSY PAPER,” which is the specific type of sheet. Also, in a case where a similar print job is given but “GLOSSY PAPER” is not loaded in the image forming apparatus 100 and “GLOSSY PHOTO PAPER” is loaded instead, printing will be executed on “GLOSSY PHOTO PAPER,” which is an alternative type of sheet, on condition that the user grants permission. On the other hand, in a case where a similar print job is given but neither “GLOSSY PAPER” nor “GLOSSY PHOTO PAPER” is loaded in the image forming apparatus 100, printing will not be executed even if another type of sheet is loaded.

In the example of FIG. 4, each individual sheet type belongs only to one alternative sheet type group. However, the sheet types and the groups are not limited to this relationship, and at least some of the sheet types may belong to multiple alternative sheet type groups. For example, while only “GLOSSYPAPER” and “GLOSSY PHOTO PAPER” belong to the second group in the example of FIG. 4, but “PLAIN PAPER” may be added to the second group. In this case, “PLAIN PAPER” belong to the first and second groups.

Instead of using the table 401 illustrated in FIG. 4, printing parameters provided for each sheet type may be utilized to search for an alternative type of sheet. The following parameters are set for each sheet type as an example of the printing parameters.
Amount of adjustment of sheet feed
Ink drying time
Sheet thickness
Amounts of inks to be used
Conveyance unit's suction strength
Calibration target
International Color Consortium (ICC) profile
   These parameters are also stored in the ROM 127 for each sheet type. The main controller 121 compares the printing parameters corresponding to the specific type of sheet and the printing parameters corresponding to each sheet type to determine whether the sheet type is an alternative type of sheet to the specific type of sheet. For example, the main controller 121 performs weighted addition of the differences between the parameters set for the specific type of sheet and the parameters set for each of the other sheet types to obtain a printing parameter difference. Then, the main controller 121 determines any sheet type with a printing parameter difference that is less than a predetermined threshold as an alternative type of sheet. Incidentally, such calculation may be done in advance, and the determination results may be stored in the ROM 127.

### Second Embodiment

The basic configuration of an image forming apparatus 100 in a second embodiment is similar to that in the first embodiment, and overlapping description is therefore omitted.

FIG. 6 is a flowchart for describing a print control method according to the second embodiment.

S601 to S606 illustrated in FIG. 6 are similar to S201 to S206 illustrated in FIG. 2, and overlapping description is therefore omitted.

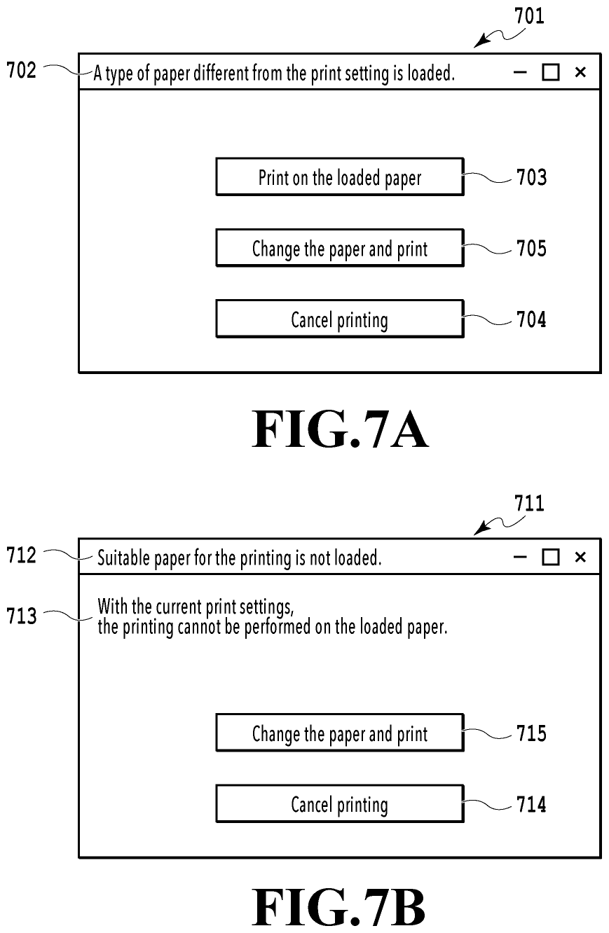

While the screen 501 (see FIG. 5A) is displayed in S207 in the first embodiment, a screen 701 (see FIG. 7A) is displayed in S607 in the second embodiment. While the screen 511 (see FIG. 5B) is displayed in S209 in the first embodiment, a screen 711 (see FIG. 7B) is displayed in S609 in the second embodiment.

The screen 701 includes, as display objects, a title 702 “A type of paper different from the print setting is loaded,” a print button 703 with a caption “Print on the loaded paper,” and a print cancel button 704 with a caption “Cancel printing.” The title 702, the print button 703, and the print cancel button 704 included in the screen 701 are similar to the title 502, the print button 503, and the print cancel button 504 included in the screen 501, respectively. The screen 701 further includes a sheet change button 705 with a caption “Change the paper and print” as a display object.

The screen 711 includes, as display objects, a title 712 “Suitable paper for the printing is not loaded,” a message 713 “With the current print settings, the printing cannot be performed on the loaded paper,” and a print cancel button 714 with a caption “Cancel printing.” The title 712, the message 713, and the print cancel button 714 included in the screen 711 are similar to the title 512, the message 513, and the print cancel button 514 included in the screen 511. The screen 711 further includes a sheet change button 715 indicating “Change the paper and print” as a display object.

The sheet change button 705 included in the screen 701 and the sheet change button 715 included in the screen 711 are similar.

If the specific type of sheet is not loaded in the image forming apparatus 100, the main controller 121 determines NO in S603, and advances the process to S606. If the alternative type of sheet is loaded in the image forming apparatus 100, the main controller 121 determines YES in S606, and advances the process to S607, in which the main controller 121 displays the screen 701 on the display unit (not illustrated) included in the operation panel 129.

If the user presses the print button 703 in the screen 701, the main controller 121 advances the process from S607 to S604 through S608.

In this case, in S604, the conveyance control unit 147 sets the sheet feeding opening to the sheet feed tray in which the alternative type of sheet is loaded in response to an instruction from the main controller 121.

Next, in S605, the print engine unit 140 executes printing on the alternative type of sheet in response to an instruction from the main controller 121.

If the user presses the print cancel button 704 in the screen 701, the main controller 121 returns the process from S607 to S601 through S608.

If the user presses the sheet change button 705 in the screen 701, the main controller 121 advances the process from S607 to S611 through S608.

The main controller 121 waits in a wait loop in S611 until the sheets are changed and, if the sheets are changed, determines YES in S611 and returns the process to S603. The main controller 121 then executes the processes in and after S603 again. Thus, in a case where the user presses the sheet change button 705 in the screen 701, the printing is suspended, and the processes in and after S603 will be resumed after the sheets are changed.

If no alternative type of sheet is loaded in any of the sheet feed trays, the main controller 121 determines NO in S606, and advances the process to S609.

In S609, the main controller 121 displays the screen 711 on the display unit (not illustrated) included in the operation panel 129.

If the user presses the print cancel button 714 in the screen 711, the main controller 121 returns the process from S609 to S601 through S610.

If the user presses the sheet change button 715 in the screen 711, the main controller 121 advances the process from S609 to S611 through S610.

The main controller 121 waits in a wait loop in S611 until the sheets are changed and, if the sheets are changed, determines YES in S611 and returns the process to S603. The main controller 121 then executes the processes in and after S603 again. Thus, in a case where the user presses the sheet change button 715 in the screen 711, the printing is suspended, and the processes in and after S603 will be resumed after the sheets are changed.

According to the second embodiment, similar advantageous effects to those of the first embodiment are achieved.

Also, according to the second embodiment, even in a case where alternative printing can be performed, the sheet change button 705 provided in the screen 701 can be pressed to newly load the specific type of sheet in the image forming apparatus 100 and then perform the original printing.

Further, according to the second embodiment, even in a case where neither the normal printing nor alternative printing cannot be performed, the sheet change button 715 provided in the screen 711 can be pressed to newly load the specific type of sheet in the image forming apparatus 100 and then perform the normal printing.

### Third Embodiment

The basic configuration of an image forming apparatus 100 in a third embodiment is similar to that in the first embodiment, and overlapping description is therefore omitted.

In the first and second embodiments, in a case where a specific type of sheet is not loaded in the image forming apparatus 100, whether an alternative type of sheet is loaded in the image forming apparatus 100 is determined, and the screen to be displayed is switched based on the result of the determination.

In contrast, in the third embodiment, in the case where a specific type of sheet is not loaded in the image forming apparatus 100, a screen for asking the user whether printing may be performed on a type of sheet that is not the specific type. At this point, whether an alternative type of sheet is loaded in the image forming apparatus 100 is not determined yet. Then, in a case where an input indicating that printing may be performed on a type of sheet that is not the specific type is received from the user, whether an alternative type of sheet is loaded in the image forming apparatus 100 is determined. In a case where an alternative type of sheet is loaded in the image forming apparatus 100, printing will be performed on the alternative type of sheet. On the other hand, in a case where an alternative type of sheet is not loaded in the image forming apparatus 100 but another type of sheet is loaded in the image forming apparatus 100, a screen for confirming whether printing may be performed on that other type of sheet is displayed. In a case where an input indicating that printing may be performed on the other type of sheet is received from the user, printing will be performed on the other type of sheet.

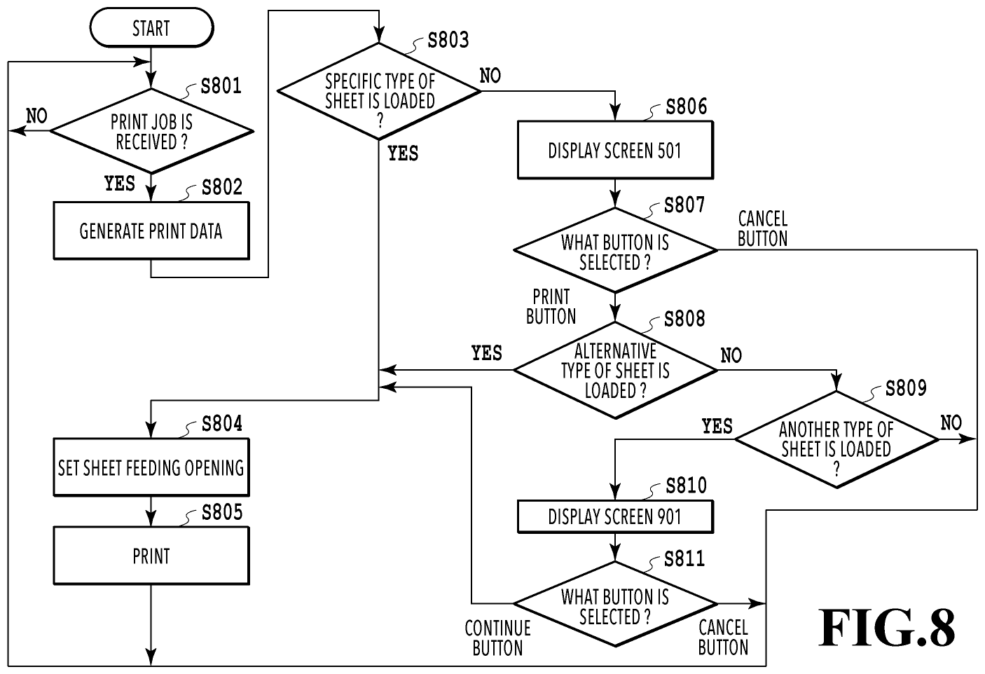

FIG. 8 is a flowchart for describing a print control method according to the third embodiment.

S801 and S803 are similar to S201 and S203 in the first embodiment, and overlapping description is therefore omitted.

If the specific type of sheet is loaded in any of the sheet feed trays, the main controller 121 determines YES in S803, and advances the process to S804.

In S804, the conveyance control unit 147 sets the sheet feeding opening to the sheet feed tray in which the specific type of sheet is loaded in response to an instruction from the main controller 121.

Next, in S805, the print engine unit 140 executes printing on the specific type of sheet in response to an instruction from the main controller 121.

If the specific type of sheet is not loaded in any of the sheet feed trays, the main controller 121 determines NO in S803, and advances the process to S806.

In S806, the main controller 121 displays the screen 501 illustrated in FIG. 5A on the display unit (not illustrated) included in the operation panel 129. The screen 501 includes the title 502 “A type of paper different from the print setting is loaded.” as a display object. The screen 501 further includes the print button 503 with a caption “Print on the loaded paper” and the print cancel button 504 with a caption “Cancel printing” as display objects.

If the user presses the print cancel button 504 in the screen 501, the main controller 121 returns the process from S806 to S801 through S807.

If the user presses the print button 503 in the screen 501, the main controller 121 advances the process from S806 to S808 through S807.

In S808, the main controller 121 determines whether an alternative type of sheet is loaded in the image forming apparatus 100.

If an alternative type of sheet is loaded in the image forming apparatus 100, the main controller 121 determines YES in S808, and advances the process to S804.

In this case, in S804, the conveyance control unit 147 sets the sheet feeding opening to the sheet feed tray in which the alternative type of sheet is loaded in response to an instruction from the main controller 121.

Next, in S805, the print engine unit 140 executes printing on the alternative type of sheet in response to an instruction from the main controller 121.

If no alternative type of sheet is loaded in the image forming apparatus 100, the main controller 121 determines NO in S808, and advances the process to S809.

In S809, the main controller 121 determines whether a type of sheet that is neither the specific type nor an alternative type (i.e., another type of sheet) is loaded in the image forming apparatus 100.

If a type of sheet that is neither the specific type nor an alternative type is loaded in the image forming apparatus 100, the main controller 121 determines YES in S809 and advances the process to S810.

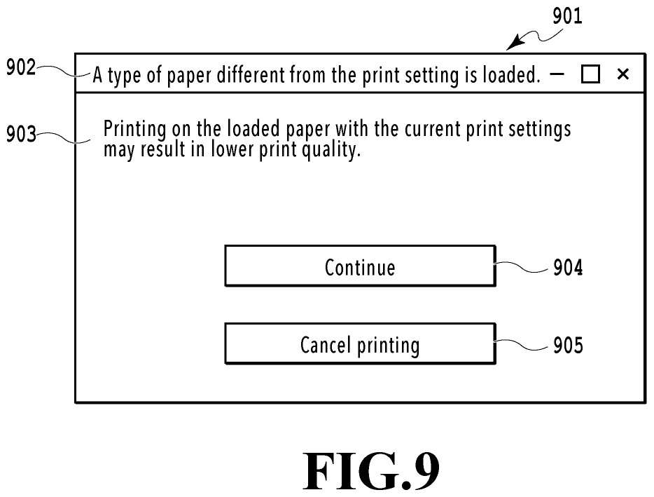

In S810, the main controller 121 displays a screen 901 illustrated in FIG. 9 on the display unit (not illustrated) included in the operation panel 129. The screen 901 includes a title 902 “A type of paper different from the print setting is loaded.” as a display object. The screen 901 further includes a message 903 “Printing on the loaded paper with the current print settings may result in lower print quality.” for giving a warning to the user as a display object. The screen 901 further includes a continue button 904 with a caption “Continue” and a print cancel button 905 with a caption “Cancel printing” as display objects.

If the user presses the continue button 904 in the screen 901, the main controller 121 advances the process from S810 to S804 through S811.

In this case, in S804, the conveyance control unit 147 sets the sheet feeding opening to the sheet feed tray in which the type of sheet that is neither the specific type nor an alternative type is loaded in response to an instruction from the main controller 121.

Next, in S805, the print engine unit 140 executes printing on the type of sheet that is neither the specific type nor an alternative type in response to an instruction from the main controller 121.

If the user presses the print cancel button 905 in the screen 901, the main controller 121 returns the process from S810 to S801 through S811.

If not even a type of sheet that is neither the specific type nor an alternative type is loaded in the image forming apparatus 100 (that is, if no sheet is loaded in the image forming apparatus 100), the main controller 121 determines NO in S809 and returns the process to S801. Incidentally, in this case, the main controller 121 may display a screen for notifying the user that no sheet is loaded in the image forming apparatus 100 on the display unit (not illustrated) included in the operation panel 129.

According to the third embodiment, in a case where the specific type of sheet is not loaded in any of the sheet feed trays, an alternative type of sheet is loaded in any of the sheet feed trays, and the user has granted permission, alternative printing can be performed on the alternative type of sheet. On the other hand, in a case where the specific type of sheet is not loaded in any of the sheet feed trays and no alternative type of sheet is loaded in any of the sheet feed trays, printing will be performed on another type of sheet on condition that the user has granted permission. This avoids execution of printing with a print quality which the user did not intend to use.

Also, according to the third embodiment, in a case where the specific type of sheet is not loaded in any of the sheet feed trays and an alternative type of sheet is loaded in any of the sheet feed trays, printing will not be performed on the alternative type of sheet if the user has not granted permission. In this way, if the user does not wish to execute alternative printing, it possible to avoid the alternative printing even in a situation where the alternative printing can be performed.

### Fourth Embodiment

The basic configuration of an image forming apparatus 100 in a fourth embodiment is similar to that in the first embodiment, and overlapping description is therefore omitted.

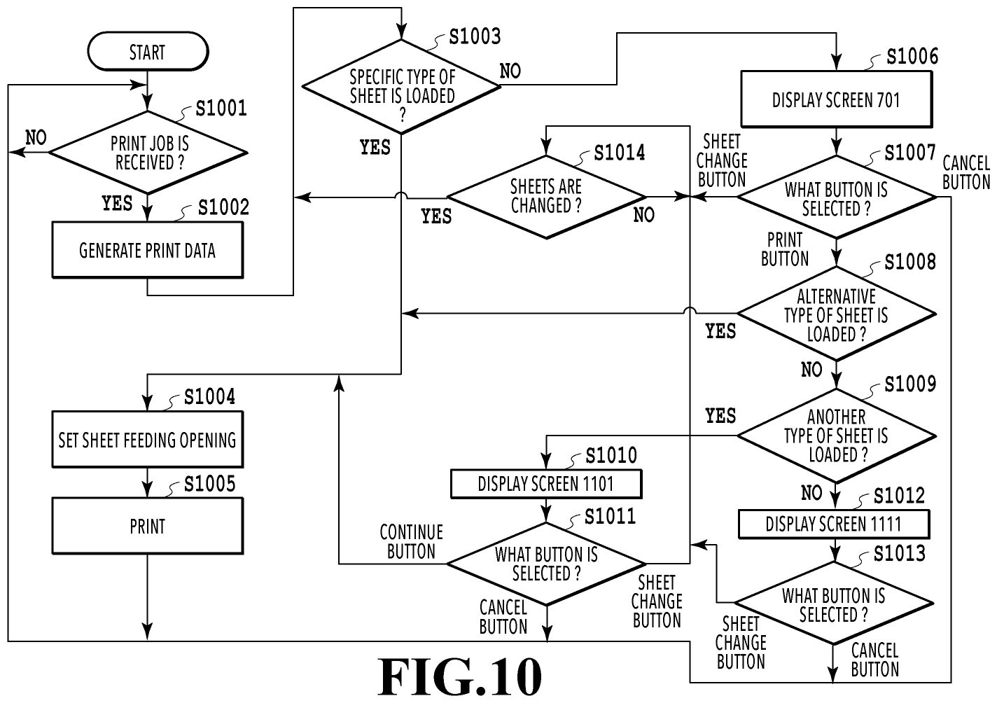

FIG. 10 is a flowchart for describing a print control method according to the fourth embodiment.

S1001 to S1005 illustrated in FIG. 10 are similar to S801 to S805 illustrated in FIG. 8, and overlapping description is therefore omitted.

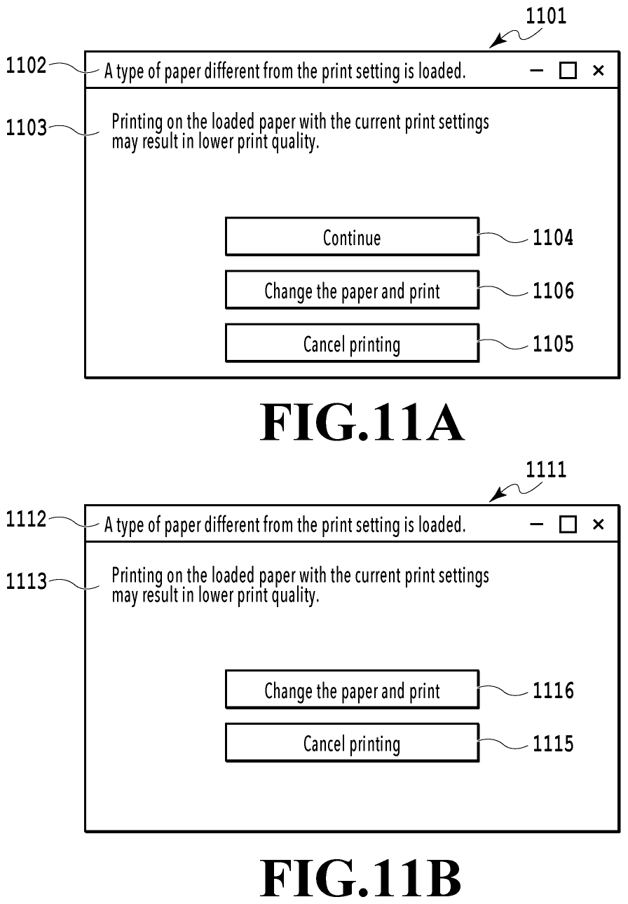

While the screen 501 (see FIG. 5A) is displayed in S806 in the third embodiment, the screen 701 (see FIG. 7A) is displayed in S1006 in the fourth embodiment. Also, while the screen 901 (see FIG. 9) is displayed in S810 in the third embodiment, a screen 1101 (see FIG. 11A) is displayed in S1010 in the fourth embodiment. Also, in the fourth embodiment, a screen 1111 (see FIG. 11B) is displayed in S1012.

As described above, the screen 701 has the title 702 “A type of paper different from the print setting is loaded.” as a display object. The screen 701 further includes the print button 703 with a caption “Print on the loaded paper” and the print cancel button 704 with a caption “Cancel printing” as display objects. The title 702, the print button 703, and the print cancel button 704 included in the screen 701 are similar to the title 502, the print button 503, and the print cancel button 504 included in the screen 501, respectively. The screen 701 further includes the sheet change button 705 with a caption “Change the paper and print.”

The screen 1101 includes a title 1102 “A type of paper different from the print setting is loaded.” as a display object. The screen 1101 further includes a message 1103 “Printing on the loaded paper with the current print settings may result in lower print quality.” for giving a warning to the user as a display object. The title 1102 and the message 1103 included in the screen 1101 are similar to the title 902 and the message 903 included in the screen 901. The screen 1101 further includes a continue button 1104 with a caption “Continue” and a print cancel button 1105 with a caption “Cancel printing” as display objects. The continue button 1104 and the print cancel button 1105 included in the screen 1101 are similar to the continue button 904 and the print cancel button 905 included in the screen 901. The screen 1101 further includes a sheet change button 1106 with a caption “Change the paper and print” as a display object.

The screen 1111 includes a title 1112 “A type of paper different from the print setting is loaded.” as a display object. The screen 1111 further includes a message 1113 “Printing on the loaded paper with the current print settings may result in lower print quality.” as a display object. The screen 1111 further has a print cancel button 1015 with a caption “Cancel printing” and a sheet change button 1016 with a caption “Change the paper and print” as a display object.

The sheet change button 705 included in the screen 701, the sheet change button 1106 included in the screen 1101, and the sheet change button 1116 included in the screen 1111 are similar.

If the specific type of sheet is not loaded, the main controller 121 determines NO in S1003, and advances the process to S1006.

In S1006, the main controller 121 displays the screen 701 illustrated in FIG. 7A on the display unit (not illustrated) included in the operation panel 129.

If the user presses the sheet change button 705 in the screen 701, the main controller 121 advances the process from S1006 to S1014 through S1007.

The main controller 121 waits in a wait loop in S1014 until the sheets are changed and, if the sheets are changed, determines YES in S1014 and returns the process to S1003. The main controller 121 then executes the processes in and after S1003 again. Thus, in a case where the user presses the sheet change button 705 in the screen 701, the printing is suspended, and the processes in and after S1003 will be resumed after the sheets are changed.

If the user presses the print cancel button 704 in the screen 701, the main controller 121 returns the process from S1006 to S1001 through S1007.

If the user presses the print button 703 in the screen 701, the main controller 121 advances the process from S1006 to S1008 through S1007.

In S1008, the main controller 121 determines whether an alternative type of sheet is loaded in the image forming apparatus 100.

If an alternative type of sheet is loaded in the image forming apparatus 100, the main controller 121 determines YES in S1008, and advances the process to S1004.

In this case, in S1004, the conveyance control unit 147 sets the sheet feeding opening to the sheet feed tray in which the alternative type of sheet is loaded in response to an instruction from the main controller 121.

Next, in S1005, the print engine unit 140 executes printing on the alternative type of sheet in response to an instruction from the main controller 121.

If no alternative type of sheet is loaded in the image forming apparatus 100, the main controller 121 determines NO in S1008, and advances the process to S1009.

In S1009, the main controller 121 determines whether a type of sheet that is neither the specific type nor an alternative type (i.e., another type of sheet) is loaded in the image forming apparatus 100.

If a type of sheet that is neither the specific type nor an alternative type is loaded in the image forming apparatus 100, the main controller 121 determines YES in S1009 and advances the process to S1010.

In S1010, the main controller 121 displays the screen 1101 illustrated in FIG. 11A on the display unit (not illustrated) included in the operation panel 129.

If the user presses the continue button 1104 in the screen 1101, the main controller 121 advances the process from S1010 to S1004 through S1011.

In this case, in S1004, the conveyance control unit 147 sets the sheet feeding opening to the sheet feed tray in which the type of sheet that is neither the specific type nor an alternative type is loaded in response to an instruction from the main controller 121.

Next, in S1005, the print engine unit 140 executes printing on the type of sheet that is neiter the specific type nor an alternative type in response to an instruction from the main controller 121.

If the user presses the print cancel button 1105 in the screen 1101, the main controller 121 returns the process from S1010 to S1001 through S1011.

If the user presses the sheet change button 1106 in the screen 1101, the main controller 121 advances the process from S1010 to S1014 through S1011.

The main controller 121 waits in the wait loop in S1014 until the sheets are changed and, if the sheets are changed, determines YES in S1014 and returns the process to S1003. The main controller 121 then executes the processes in and after S1003 again. Thus, in a case where the user presses the sheet change button 1106 in the screen 1101, the printing is suspended, and the processes in and after S1003 will be resumed after the sheets are changed.

If not even a type of sheet that is neither the specific type nor an alternative type is loaded in the image forming apparatus 100 (if no sheet is loaded in the image forming apparatus 100), the main controller 121 determines NO in S1009 and advances the process to S1012.

In S1012, the main controller 121 displays the screen 1111 illustrated in FIG. 11B on the display unit (not illustrated) included in the operation panel 129.

If the user presses the print cancel button 1115 in the screen 1111, the main controller 121 returns the process from S1012 to S1001 through S1013.

If the user presses the sheet change button 1116 in the screen 1111, the main controller 121 advances the process from S1012 to S1014 through S1013.

The main controller 121 waits in the wait loop in S1014 until the sheets are changed and, if the sheets are changed, determines YES in S1014 and returns the process to S1003. The main controller 121 then executes the processes in and after S1003 again. Thus, in a case where the user presses the sheet change button 1116 in the screen 1111, the printing is suspended, and the processes in and after S1003 will be resumed after the sheets are changed.

According to the fourth embodiment, similar advantageous effects to those of the third embodiment are achieved.

Also, according to the fourth embodiment, even in a case where alternative printing can be performed, the sheet change button 705 provided in the screen 701 can be pressed to newly load the specific type of sheet in the image forming apparatus 100 and then perform the normal printing.

Further, according to the fourth embodiment, even in a case where neither the original printing nor alternative printing can be performed, the sheet change button 1106 provided in the screen 1101 can be pressed to newly load the specific type of sheet in the image forming apparatus 100 and perform the original printing.

Further, according to the fourth embodiment, even in a case where no sheets are printable, the sheet change button 1116 provided in the screen 1111 can be pressed to newly load the specific type of sheet in the image forming apparatus 100 and perform the original printing.

### Fifth Embodiment

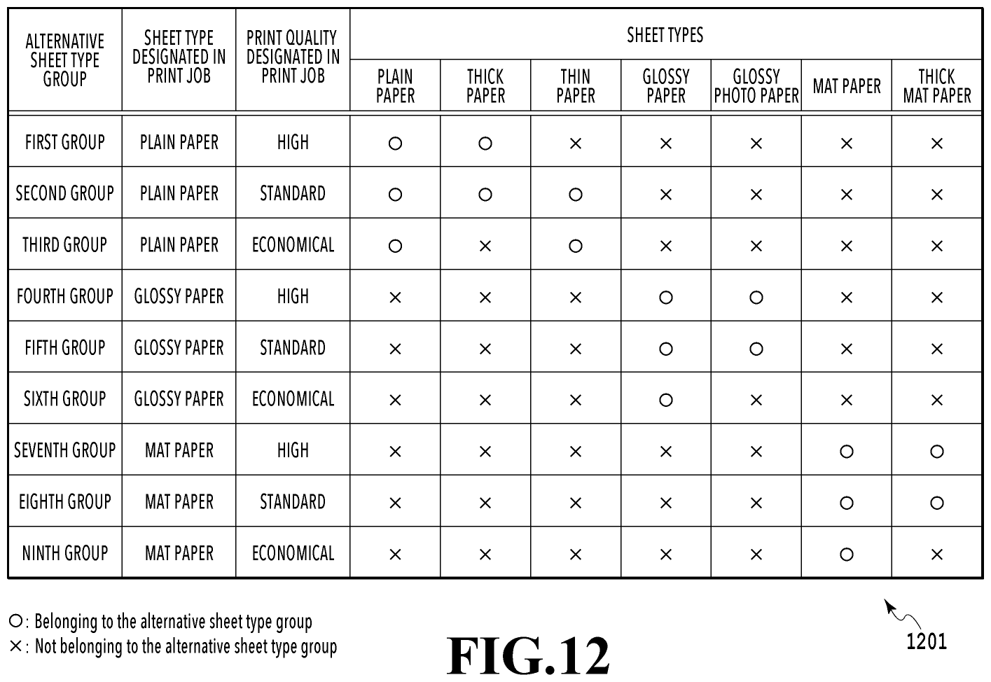

In the first to fourth embodiments, the table 401 illustrated in FIG. 4, for example, is used to search for an alternative type of sheet. In a fifth embodiment, a table 1201 illustrated in FIG. 12 is used instead of the table 401 illustrated in FIG. 4.

The table 1201 lists alternative types of sheets for combinations of specific types of sheets and print qualities. With the table 1201, print jobs designating the same specific type of sheet can have different alternative types of sheets based on the print quality designated in the print job.

For example, in a case where the sheet type designated in a print job is plain paper and the print quality designated in the print job is “High,” thick paper is the only alternative type of sheet to the specific type of sheet, which is plain paper. Also, in a case where the sheet type designated in a print job is plain paper and the print quality designated in the print job is “Standard,” thick paper and thin paper are alternative types of sheets to the specific type of sheet, which is plain paper. Further, in a case where the sheet type designated in a print job is plain paper and the print quality designated in the print job is “Economical,” only thin paper is the alternative type of sheet to the specific type of sheet, which is plain paper.

### Sixth Embodiment

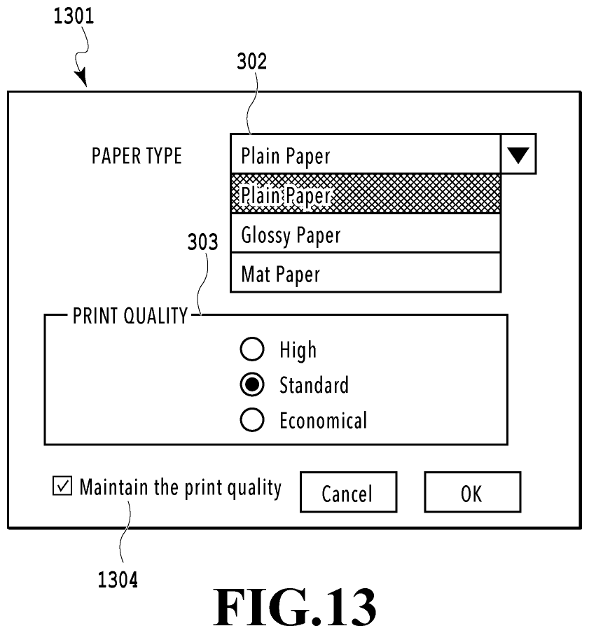

In the first to fifth embodiments, the screen 301 as illustrated in FIG. 3 is displayed on the host apparatus 110 by the printer driver, and the user uses this screen 301 to designate a sheet type and a print quality. In contrast, in the sixth embodiment, a screen 1301 as illustrated in FIG. 13 is displayed on the host apparatus 110 by the printer driver, and the user uses this screen 1301 to designate a sheet type and a print quality. The screen 1301 includes the menu 302 for the user to designate a sheet type and the menu 303 for the user to designate a print quality and additionally a checkbox 1304 for the user to enable or disable maintaining of the print quality as display objects.

In the sixth embodiment, in a case where the user uses the checkbox 1304 to enable the maintaining of the print quality, operations similar to any of the first to fifth embodiments will be performed. Also in the sixth embodiment, in a case where the user uses the checkbox 1304 to disable the maintaining of the print quality, operations similar to any of the first to fifth embodiments will be performed with all sheet types excluding the designated type as alternative types of sheets. To this end, a row for an alternative sheet type group containing all sheet types, for example, is added to the table 401 illustrated in FIG. 4. Moreover, in a case where information indicating that the checkbox 1304 is not checked is transmitted to the image forming apparatus 100 from the host apparatus 110, the image forming apparatus 100 refers to that row in S206, S606, S808, or S1008.

### Seventh Embodiment

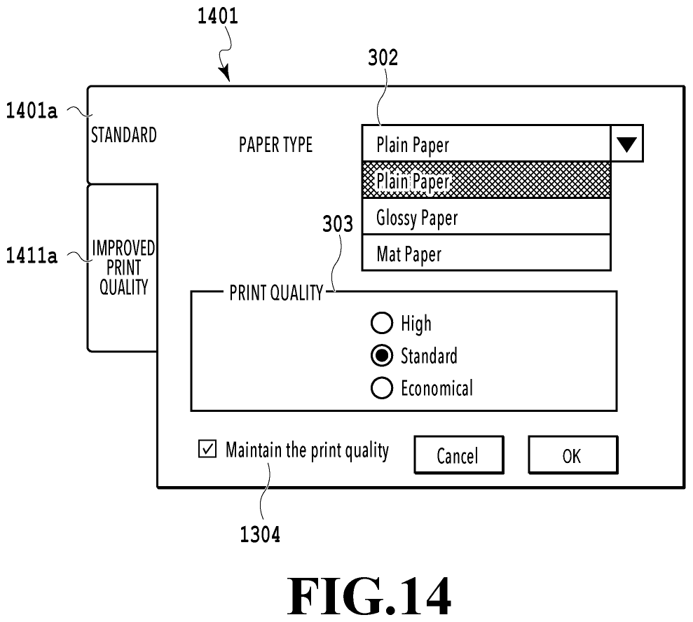

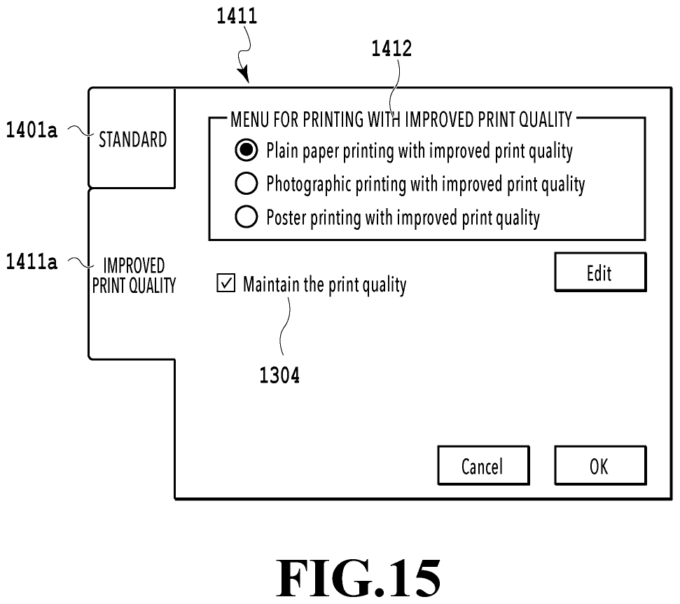

In a seventh embodiment, a screen 1401 as illustrated in FIG. 14 or a screen 1411 as illustrated in FIG. 15 is displayed on the host apparatus 110 by the printer driver. The user can switch the display between the screens 1401 and 1411 by, for example, selecting a tab 1401a or 1411a.

The screen 1401 is similar to the screen 1301, and includes the menu 302 for selecting a sheet type, the menu 303 for selecting a print quality, and the checkbox 1304 for enabling or disabling maintaining of the print quality as display objects.

In a case where the screen 1401 is displayed as a result of the user selecting the tab 1401a, the image forming apparatus 100 operates in a similar manner to the sixth embodiment.

In a case where the screen 1411 is displayed as a result of the user selecting the tab 1411a, the image forming apparatus 100 operates as described below.

The screen 1411 includes a print quality improving menu 1412 as a display object. The print quality improving menu 1412 has the following menu items as one example.
Plain paper printing with improved print quality
Photographic printing with improved print quality
Poster printing with improved print quality
   Plain paper is associated as a specific type of sheet with “Plain paper printing with improved print quality” in advance. Glossy paper is associated as a specific type of sheet with “Photographic printing with improved print quality” in advance. Mat paper is associated as a specific type of sheet with “Poster printing with improved print quality” in advance.

In a case of performing printing with the menu item “Plain paper printing with improved print quality” selected, the image forming apparatus 100 operates in a similar manner to the sixth embodiment with plain paper as the specific type of sheet. In a case of performing printing with the menu item “Photographic printing with improved print quality” selected, the image forming apparatus 100 operates in a similar manner to the sixth embodiment with glossy paper as the specific type of sheet. In a case of performing printing with the menu item “Poster printing with improved print quality” selected, the image forming apparatus 100 operates in a similar manner to the sixth embodiment with mat paper as the specific type of sheet. Note that the checkbox 1304 for maintaining the print quality may be removed from the screen 1411, and operations similar to those in any of the first to fifth embodiments may always be performed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-2.17860, filed on Dec. 25, 2023, which is hereby incorporated by reference wherein in its entirety.

What is claimed is:

1. An image forming apparatus comprising an execution control unit that, in a case where a specific type of sheet associated with print data is not loaded in the image forming apparatus and an alternative type of sheet is loaded in the image forming apparatus, causes a print engine unit to execute printing based on the print data on the alternative type of sheet.

2. The image forming apparatus according to claim 1, further comprising a display control unit that displays a first screen capable of accepting permission for printing on the alternative type of sheet from a user in the case where the specific type of sheet is not loaded in the image forming apparatus and the alternative type of sheet is loaded in the image forming apparatus, wherein
the execution control unit causes the print engine unit to execute the printing based on the print data on the alternative type of sheet in a case where the specific type of sheet is not loaded in the image forming apparatus, the alternative type of sheet is loaded in the image forming apparatus, and the first screen accepts the permission from a user.

3. The image forming apparatus according to claim 2, wherein
the first screen is capable of accepting a choice to change a sheet from a user, and
in a case where the first screen accepts the choice to change a sheet from a user, the execution control unit suspends the execution of the printing based on the print data by the print engine unit, and resumes an operation for the print data after the sheet is changed.

4. The image forming apparatus according to claim 2, wherein
the first screen is capable of accepting a choice to cancel printing from a user, and
the execution control unit cancels the execution of the printing based on the print data by the print engine unit in a case where the first screen accepts the choice to cancel printing from a user.

5. The image forming apparatus according to claim 2, wherein in a case where the specific type of sheet is not loaded in the image forming apparatus and the alternative type of sheet is also not loaded in the image forming apparatus, the display control unit does not display the first screen and the execution control unit cancels the execution of the printing based on the print data by the print engine unit.

6. The image forming apparatus according to claim 2, wherein
in a case where the specific type of sheet is not loaded in the image forming apparatus and the alternative type of sheet is also not loaded in the image forming apparatus, the display control unit displays a second screen capable of accepting a choice to change a sheet from a user, and
in a case where the second screen accepts the choice to change a sheet from a user, the execution control unit suspends the execution of the printing based on the print data by the print engine unit, and resumes an operation for the print data after the sheet is changed.

7. The image forming apparatus according to claim 6, wherein
the second screen is capable of accepting a choice to cancel printing from a user, and
the execution control unit cancels the execution of the printing based on the print data by the print engine unit in a case where the second screen accepts the choice to cancel printing from a user.

8. The image forming apparatus according to claim 1, further comprising a display control unit that, in a case where the specific type of sheet is not loaded in the image forming apparatus and the alternative type of sheet is also not loaded in the image forming apparatus, displays a third screen for giving a warning to a user and obtaining permission from the user for printing on a type of sheet that is neither the specific type nor the alternative type, wherein
in a case where the specific type of sheet is not loaded in the image forming apparatus, the alternative type of sheet is not loaded in the image forming apparatus, and the permission is input into the third screen from a user, the execution control unit causes the print engine unit to execute the printing based on the print data on the type of sheet that is neither the specific type nor the alternative type.

9. The image forming apparatus according to claim 8, wherein
the third screen is capable of accepting a choice to change a sheet from a user, and
in a case where the third screen accepts the choice to change a sheet from a user, the execution control unit suspends the execution of the printing based on the print data by the print engine unit, and resumes an operation for the print data after the sheet is changed.

10. The image forming apparatus according to claim 8, wherein
the third screen is capable of accepting a choice to cancel printing from a user, and
the execution control unit cancels the execution of the printing based on the print data by the print engine unit in a case where the third screen accepts the choice to cancel printing from a user.

11. The image forming apparatus according to claim 1, further comprising a display control unit that, in a case where the specific type of sheet is not loaded in the image forming apparatus, displays a fourth screen capable of accepting permission for printing on a type of sheet that is not the specific type from a user, wherein
after the fourth screen accepts the permission from a user, the execution control unit determines whether the alternative type of sheet is loaded in the image forming apparatus, and
the execution control unit causes the print engine unit to execute the printing based on the print data on the alternative type of sheet in a case where the specific type of sheet is not loaded in the image forming apparatus, the fourth screen accepts the permission from a user, and the alternative type of sheet is loaded in the image forming apparatus.

12. The image forming apparatus according to claim 11, wherein
the fourth screen is capable of accepting a choice to cancel printing on the type of sheet that is not the specific type from a user, and
the execution control unit cancels the execution of the printing based on the print data by the print engine unit in a case where the fourth screen accepts the choice to cancel printing from a user.

13. The image forming apparatus according to claim 11, wherein
the fourth screen is capable of accepting a choice to change a sheet from a user, and
in a case where the fourth screen accepts the choice to change a sheet from a user, the execution control unit suspends the execution of the printing based on the print data by the print engine unit, and resumes an operation for the print data after the sheet is changed.

14. The image forming apparatus according to claim 11, wherein
in a case where the specific type of sheet is not loaded in the image forming apparatus, the permission is input into the fourth screen from a user, and the alternative type of sheet is not loaded in the image forming apparatus, the display control unit displays a fifth screen for giving a warning to the user and obtaining permission from the user for printing on a type of sheet that is neither the specific type nor the alternative type, and
in a case where the specific type of sheet is not loaded in the image forming apparatus, the alternative type of sheet is not loaded in the image forming apparatus, and the permission for printing on a type of sheet that is neither the specific type nor the alternative type is input into the fifth screen from a user, the execution control unit causes the print engine unit to execute the printing based on the print data on the type of sheet that is neither the specific type nor the alternative type.

15. The image forming apparatus according to claim 14, wherein
the fifth screen is capable of accepting a choice to change a sheet from a user, and
in a case where the fifth screen accepts the choice to change a sheet from a user, the execution control unit suspends the execution of the printing based on the print data by the print engine unit, and resumes an operation for the print data after the sheet is changed.

16. The image forming apparatus according to claim 1, wherein the execution control unit causes the print engine unit to execute the printing based on the print data on the specific type of sheet in a case where the specific type of sheet is loaded in the image forming apparatus.

17. The image forming apparatus according to claim 1, wherein the alternative type of sheet is a type of sheet for which information on a fact that the type of sheet can be an alternative to the specific type of sheet is stored in a storage unit accessible to the image forming apparatus.

18. The image forming apparatus according to claim 1, wherein the alternative type of sheet is a type of sheet for which information on a fact that the type of sheet can be an alternative to a combination of the specific type of sheet and a print quality is stored in a storage unit accessible to the image forming apparatus.

19. The image forming apparatus according to claim 1, wherein the alternative type of sheet is a sheet determined as the alternative type of sheet to the specific type of sheet by comparing a printing parameter corresponding to the specific type of sheet and a printing parameter corresponding to the alternative type of sheet to each other.

20. A print control method comprising, in a case where a specific type of sheet associated with print data is not loaded in an image forming apparatus and an alternative type of sheet is loaded in the image forming apparatus, causing a print engine unit to execute printing based on the print data on the alternative type of sheet.

21. A computer readable medium on which a computer program is recorded, the computer program, when executed, causing a computer to function as an execution control unit that, in a case where a specific type of sheet associated with print data is not loaded in an image forming apparatus and an alternative type of sheet is loaded in the image forming apparatus, causes a print engine unit to execute printing based on the print data on the alternative type of sheet.
